(19) United States
(12) Patent Application Publication
(10) Pub. No.: US 2018/0303123 A1
(43) Pub. Date: Oct. 25, 2018

(54) STABILIZED FROZEN DESSERT COMPOSITION

(71) Applicant: FMC (SHANGHAI) COMMERCIAL ENTERPRISE, Shanghai (CN)

(72) Inventor: Yin Zhou, Shanghai (CN)

(21) Appl. No.: 15/578,980

(22) PCT Filed: Jun. 16, 2016
(86) PCT No.: PCT/CH2016/085959

§ 371 Date: Dec. 1, 2017

(30) Foreign Application Priority Data
Jun. 17, 2015 (CN) 201510338296.2

(51) Int. Cl. A23G 9/34; A23G 9/42; A23G 9/44

(52) U.S. Cl. CPC A23G 9/34; A23G 9/42; A23V 2250/51084; A23V 2002/00; A23V 2250/5066; A23G 9/44

(57) ABSTRACT

A frozen dessert comprising a stabilizer composition comprised of non-coprocessed colloidal microcrystalline cellulose and konjac wherein the weight ratio of colloidal microcrystalline cellulose to konjac is from 4:6 to 1:9. Such frozen dessert exhibits unexpectedly desirable anti-meltdown and heatshock resistance coupled with unexpectedly desirable organoleptic properties.

### SUMMARY OF THE INVENTION

The present invention is directed to a frozen dessert comprising a stabilizer composition comprised of non-coprocessed colloidal microcrystalline cellulose and konjac wherein the weight ratio of colloidal microcrystalline cellulose to konjac is from 4:6 to 1:9. Such frozen dessert exhibits unexpectedly desirable anti-meltdown and heatshock resistance, coupled with unexpectedly desirable organoleptic properties.

### BACKGROUND OF THE INVENTION

In the food industry, the term “frozen desserts” is a market category that encompasses a wide variety of products that are served at temperatures below the freezing point of water. Frozen desserts include dairy-based food desserts such as ice cream, ice milk, sherbet, gelato, frozen yogurt, soft serve ice cream; nondairy-based desserts such as mellorine, sorbet, and water ices; and specialty items such as frozen novelties, e.g., bars, cones, and sandwiches. Frozen desserts also include reduced fat (also called low-fat or light) and no fat (also called fat-free) versions of many of these frozen desserts. In recent years, reduced fat frozen desserts and no fat frozen desserts have become a significant, growing segment of the frozen desserts market.

Frozen desserts typically are multiphase compositions: solid, liquid and air, with the liquid sometimes including oil and water phases. This characteristic of frozen desserts, which is the basis for their food appeal to consumers, presents the manufacturer with difficulties in maintaining the desired product qualities until the frozen dessert is ultimately consumed. Negative sensory characteristics in frozen desserts usually result from perceived body or textural defects. A particularly common textural defect in frozen desserts results from the formation of large ice crystals, a problem often aggravated by fluctuations in storage temperature.

Problems associated with meltdown and heat shock are particularly of concern in developing countries where poor cold chain distribution of frozen desserts exist. Accordingly, it would be desirable to possess frozen desserts that exhibited superior meltdown and heat shock resistance.

U.S. Pat. No. 5,462,761 (McGinley et al) discloses the use of microcrystalline cellulose/konjac aggregates, produced by the coprocessing of such materials, as bulking agents in food products, including low fat frozen desserts. However, McGinley et al indicate that the microcrystalline cellulose component of such materials should contain 60-99% and preferably 70-90% of the solids weights of the microcrystalline cellulose/konjac composition. However, Applicants have found that when non-coprocessed colloidal microcrystalline cellulose and konjac are added to frozen desserts at such preferred ratios, the meltdown performance of the resulting dessert is worse than when either of such components are employed alone. Consequently, it is unexpected that varying the weight ratio of such components such that it is outside the range of those described as being useful by McGinley et al would exhibit improved meltdown resistance relative to the use of colloidal microcrystalline cellulose or konjac alone.

### SUMMARY OF THE INVENTION

The present invention is directed to a frozen dessert comprising a stabilizer composition comprised of non-coprocessed colloidal microcrystalline cellulose and konjac wherein the weight ratio of microcrystalline cellulose to konjac is from 4:6 to 1:9.

### DETAILED DESCRIPTION OF THE INVENTION

The present invention is directed to a frozen dessert comprising a stabilizer composition comprised of non-coprocessed colloidal microcrystalline cellulose and konjac wherein the weight ratio of colloidal microcrystalline cellulose to konjac is from 4:6 to 1:9.

As is employed herein, the term “non-coprocessed colloidal microcrystalline cellulose and konjac” means colloidal microcrystalline cellulose and konjac which have not been coattrited or otherwise co-processed with each other so as to form an aggregate.

The microcrystalline cellulose employed in the practice of the present invention is colloidal. Colloidal microcrystalline cellulose, such as the carboxymethyl cellulose-coated microcrystalline cellulose described in U.S. Pat. No. 3,539,365 (Durand et al.) is well known to those of skill in the art and is typically produced by attriting a protective colloid (such as sodium carboxy-methylcellulose) with microcrystalline cellulose. The protective colloid wholly or partially neutralizes the hydrogen or other bonding forces between the smaller sized particles. FMC Corporation (Philadelphia, Pa., USA) manufactures and sells various grades of this product which comprise co-processed microcrystalline cellulose and sodium carboxymethylcellulose under the designations of, among others, AVICEL®, NOVAGEL® and GELSTAR®.

The konjac used in the present invention may be native (crude) konjac powder, clarified konjac glucomannan, cold-melt konjac or purified konjac galactomannan, all of which are known in the art.

The weight ratio of colloidal microcrystalline cellulose to konjac is typically from 4:6 to 1:9; is more typically from 4:6 to 2:8; and is most typically about 3:7.

Frozen desserts include dairy-based food desserts such as ice cream, ice milk, sherbet, gelato, frozen yogurt, soft serve ice cream, and milk shakes; nondairy-based desserts such as mellorine, sorbet, and water ices; and specialty items such as frozen novelties, e.g., bars, cones, and sandwiches. The formulation and manufacture of frozen desserts is well known to those skilled in the art and is available from many sources, including the internet. The composition and labeling of many of these products is controlled by governmental regulation, which may vary from country to country. For example, one regulation requires that ice cream contains at least 10% milk fat and at least 20% milk solids. Low fat ice cream contains a maximum of 3 grams of total fat per serving (½ cup), and nonfat ice cream contains less than 0.5 grams of total fat per serving.

Ice cream is a frozen dessert made from a mixture of dairy and non-dairy products to give the desired level of fat and “milk solids non-fat” (MSNF), which, together with sugar, sweetener, flavoring, coloring, emulsifier, and stabilizer, is made smooth by whipping or stirring during the freezing process. Ice cream is a complex mixture containing ice crystals, fat globules and air cells. The ice crystals and fat globules are very small and well divided in order to produce a smooth texture without any “fatty taste”.

Ice cream includes a dairy source, such as whole milk, skim milk, condensed milk, evaporated milk, anhydrous milk fat, cream, butter, butterfat, whey, and/or milk solids non-fat (“MSNF”). The dairy source contributes dairy fat and/or non-fat milk solids such as lactose and milk proteins, e.g., whey proteins and caseins. Vegetable fat, for example, cocoa butter, palm, palm kernal, sal, soybean, cottonseed, coconut, rapeseed, canola, sunflower oils, and mixtures thereof, may also be used. MSNF is made up of approximately 38% milk protein, 54% lactose, and 8% minerals and vitamins.

The sugar used may be sucrose, glucose, fructose, lactose, dextrose, invert sugar either crystalline or liquid syrup form, or mixtures thereof. The sweetener may be a corn sweetener in either a crystalline form of refined corn sugar (dextrose and fructose), a dried corn syrup (corn syrup solids), a liquid corn syrup, a maltodextrin, glucose, or a mixture thereof. Sugar substitutes, sometimes called high potency sweeteners, such as sucralose, saccharin, sodium cyclamate, aspartame, and acesulfame may be used in addition to or in place of some or all of the sugar.

Air is typically incorporated to provide desirable properties. The amount of air incorporated is referred to as “overrun”. Overrun is expressed as a percentage, and refers to the relative volumes of air and mix in the package. For example, ice cream in which the volume of air is exactly equal to the volume of mix is said to have 100% overrun. When overrun is properly incorporated, it is in the form of finely divided and evenly distributed air cells that help provide structure and creaminess. The air cells are dispersed in the liquid portion, which contains the other ingredients of the ice cream. The overrun for ice cream products aerated using a conventional freezer is in the range of about 20% to about 250%, preferably of about 40% to about 175%, more preferably of about 80% to about 150%. The overrun for molded ice cream products aerated using a whipper is in the range of about 40% to about 200%, preferably of about 80% to about 150%. The overrun for aerated water ice is in the range of about 5% to about 100%, preferably of about 20% to about 60%.

Other ingredients of ice cream include, for example, flavorings, colorings, emulsifiers, and water. These ingredients are well known to those skilled in the art. Emulsifiers include, for example, propylene glycol monostearate; sorbitan tristearate; lactylated monoglycerides and diglycerides; acetylated monoglycerides and diglycerides; unsaturated monoglycerides and diglycerides, including monoglycerides and diglycerides of oleic acid, linoleic acid, linolenic acid, or other commonly available higher unsaturated fatty acids; and mixtures thereof. Emulsifiers typically comprise about 0.01% to about 3% of the mix. In addition to all the other ingredients in the formulation, water makes up the balance of the mix.

Gelato is similar to ice cream, but contains more milk than cream and also contains sweeteners, egg yolks and flavoring. Mellorine is a frozen dessert in which vegetable fat has replaced cream. Italian-style gelato is denser than ice cream, because it contains less overrun. Sherbets have a milkfat content of between 1% and 2%, MSNF up to about 5 wt %, and slightly higher sweetener content than ice cream. Sherbet is flavored either with fruit or other characterizing ingredients. Frozen yogurt consists of a mixture of dairy ingredients such as milk and nonfat milk that have been cultured with a yogurt culture, as well as ingredients for sweetening and flavoring. Following pasteurization typical for ice cream processing, the composition is inoculated with a yogurt culture. When the desired acidity had been attained, it is cooled. Frozen custard or French ice cream must also contain a minimum of 10% milkfat, as well as at least 1.4% egg yolk solids. Sorbet and water ices are similar to sherbets, but contain no dairy ingredients.

The frozen desserts of this invention are typically prepared by adding the colloidal microcrystalline cellulose and konjac to the dairy source component prior to homogenization and pasteurization. Such desserts exhibit unexpectedly desirable meltdown resistance as well as unexpectedly desirable organoleptic properties.

### EXAMPLES

### Example 1

Pre-blends were produced comprising the mixture in Table 1 below in which:
The colloidal MCC is NOVAGEL GP 3282
MDG is mono and diglycerides, a typical emulsifier used in ice cream production.
DMG is distilled monoglycerides, which has more than 95% of monoglycerides.

TABLE 1

| | | MCC: | | MCC: | |
|---|---|---|---|---|---|
| | | Konjac | MCC: | Konjac | |
| Ingredients Name | MCC | (7:3) | Konjac (5:5) | (3:7) | Konjac |
| Colloidal MCC | 2250 | 1575 | 1125 | 675 | 0 |
| Konjac | 0 | 675 | 1125 | 1575 | 2250 |
| Emulsifier MDG | 625 | 625 | 625 | 625 | 625 |
| Emulsifier DMG | 1425 | 1425 | 1425 | 1425 | 1425 |
| Guar | 325 | 325 | 325 | 325 | 325 |
| Carrageenan | 225 | 225 | 225 | 225 | 225 |
| Dextrose | 150 | 150 | 150 | 150 | 150 |
| Monohydrate | | | | | |
| Gum dosage | 2800 | 2800 | 2800 | 2800 | 2800 |
| Sum Pre-Blend | 5000 | 5000 | 5000 | 5000 | 5000 |

These pre-blends were added to the ice cream formulation set forth in Table 2 below employing the process set forth below:

TABLE 2

| Ingredients | Percentage |
|---|---|
| Pre-blend | 0.5 |
| Sugar | 13 |
| Maltodextrin | 3.5 |
| Glucose Syrup | 3.5 |
| Whole Milk Powder | 4.5 |
| Whey Powder | 3.2 |
| Palm Oil | 5.5 |
| Water | 66.3 |
| Total | 100 |

### Preparation Method

1. Dissolve milk powder into hot water at 55° C. for 10 minutes.
2. Heat up the milk solution to 70° C., and then slowly add the pre-blend mixed with 5 times sugar to the milk solution and vigorously stir for 10 minutes.
3. Add the rest of the sugar, glucose syrup pre-dissolved in 2 times hot water and maltodextrin into the above mix and stir for 5 minutes.
4. Add pre-melted oil and vigorously mix for 5 minutes.
5. Homogenize the above mix at 200/30 Bar
6. Pasteurize at 85° C. for 30 seconds
7. Cool down to 4° C. and age at 4° C. for at least 4 hours.
8. Make ice cream using freezer (Taylor KF80) with filling temperature at −5.5° C. and with overrun at about 90%.

### Evaluation Method (Meltdown Test)

The aim of this test is to evaluate the structural stability of ice cream at controlled room temperature. The measurement of the melting behavior of ice cream provides important information about the product structure stability. The product was placed on a meltdown weighing system in the incubator with the temperature controlled. The amount of liquid that dripped during the melting of the product at room temperature (22- 25° C.) was monitored by weighing at regular time intervals. The result of such testing is summarized in Table 3:

TABLE 3
Meltdown Test Result
The percentage of remained weight of ice cream (non-melted ice cream) based on
the initial ice cream bulk weight for each sample is recorded in the below table. The
higher number indicates better anti-melt down performance.

| | | MCC: | MCC: | MCC: | |
|---|---|---|---|---|---|
| | | Konjac | Konjac | Konjac | |
| Time (mins) | MCC | (7:3) | (5:5) | (3:7) | Konjac |
| 0 | 100% | 100% | 100% | 100% | 100% |
| 15 | 100% | 100% | 100% | 100% | 100% |
| 30 | 100% | 100% | 100% | 100% | 100% |
| 45 | 100% | 99% | 100% | 100% | 99% |
| 60 | 100% | 97% | 99% | 100% | 97% |
| 75 | 99% | 93% | 97% | 99% | 94% |
| 90 | 97% | 87% | 94% | 97% | 91% |
| 105 | 96% | 83% | 92% | 95% | 89% |
| 120 | 93% | 79% | 89% | 93% | 88% |
| 135 | 84% | 69% | 83% | 87% | 85% |
| 150 | 80% | 62% | 80% | 85% | 83% |
| 165 | 77% | 58% | 78% | 84% | 82% |
| 180 | 74% | 52% | 76% | 83% | 81% |

The above results show that when added at weight ratios of less than 5:5 of MCC:konjac, the frozen dessert exhibited melt down resistance equal or superior to that of konjac or MCC alone. In contrast, when employed at a 7:3 MCC:konjac weight ratio, the melt down resistance of the frozen dessert was considerably reduced.

Samples of the above compositions were provided to a taste panel who evaluated certain of their organoleptic properties, including the following sensory attributes:

| | |
|---|---|
| Coldness | Thermal perception at the first contact of the ice cream with |
| | the tongue, teeth and palate. |
| Smoothness | The absence of particles (e.g. ice-crystals or sandy particles) |
| | in the ice cream mass. |
| Melting Rate | Speed at which the ice cream melts (e.g. becomes liquid) |
| | when compressed between tongue and palate. |
| Mouth Coating | The amount and persistence of the film that coats mouth and |
| | palate after swallowing. |

The results of such testing are summarized in Table 4. In such Table, higher numbers represent a higher degree of effect, measured on a scale of 1-6.

TABLE 4

| | | MCC:Konjac | MCC:Konjac | MCC:Konjac | |
|---|---|---|---|---|---|
| | MCC | (7:3) | (5:5) | (3:7) | Konjac |
| Coldness | 3 | 6 | 5 | 1 | 1 |
| Smoothness | 3 | 0 | 1 | 6 | 5 |
| Melting Rate | 4 | 6 | 3 | 0 | 1 |
| Mouth Coating | 1 | 2 | 3 | 5 | 5 |

The above results indicate the following:
Coldness: MCC: Konjac (3:7) and Konjac exhibited a warm mouthfeel which is desirable from a consumer perspective. The MCC: Konjac (7:3) and MCC: Konjac (5:5) exhibit a cold mouthfeel which is believed due to the presence of large ice crystals.
Smoothness: MCC: Konjac (3:7) provided the best results.
Melting Rate: MCC: Konjac (3:7) had the lowest melting rate, which correlates to the meltdown test result above.
Mouth coating: MCC: Konjac (3:7) and Konjac exhibited good mouth coating which correlates to creaminess.

What is claimed is:

1. A frozen dessert comprising a stabilizer composition comprised of non-coprocessed colloidal microcrystalline cellulose and konjac wherein the weight ratio of colloidal microcrystalline cellulose to konjac is from 4:6 to 1:9.

2. The frozen dessert of claim 1 wherein the weight ratio of colloidal microcrystalline cellulose to konjac is from 4:6 to 2:8.

3. The frozen dessert of claim 1 wherein the weight ratio of colloidal microcrystalline cellulose to konjac is 3:7.

4. The frozen dessert of claim 1 wherein such dessert is selected from the group consisting of ice cream, ice milk, sherbet, gelato, frozen yogurt, soft serve ice cream, milk shakes, mellorine, sorbet, and water ice.

5. The frozen dessert of claim 4 wherein such dessert is ice cream.
